(19) United States
(12) Patent Application Publication
(10) Pub. No.: US 2012/0088499 A1
(43) Pub. Date: Apr. 12, 2012

(54) TD-SCDMA MEASUREMENT IN A DUAL TD-SCDMA AND GSM MOBILE STATION

(76) Inventors: Tom Chin, San Diego, CA (US); Guangming Shi, San Diego, CA (US); Kuo-Chun Lee, San Diego, CA (US)

(21) Appl. No.: 12/903,105

(22) Filed: Oct. 12, 2010

(51) Int. Cl. H04W 48/00; H04W 24/00

(52) U.S. Cl. 455/426.1; 455/435.2

(57) ABSTRACT

Certain aspects of the present disclosure provide techniques and apparatus for performing cell reselection based on neighbor cell measurements. For certain aspects, a method of wireless communication generally includes, while actively served in a first Radio Access Technology (RAT) network, obtaining neighbor cell measurements for a second RAT network, and making a decision on whether to perform a cell reselection to the second RAT network based on the neighbor cell measurements.

### BACKGROUND

1. Field

Certain aspects of the present disclosure relate generally to wireless communication systems, and more particularly, to techniques for TD-SCDMA measurement in a dual TD-SCDMA and GSM mobile station.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, in certain locations, TD-SCDMA is being pursued as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but also to advance and enhance the user experience with mobile communications.

### SUMMARY

In an aspect of the disclosure, a method for wireless communications is provided. The method generally includes, while actively served in a first Radio Access Technology (RAT) network, obtaining neighbor cell measurements for a second RAT network; and making a decision on whether to perform a cell reselection to the second RAT network based on the neighbor cell measurements.

In an aspect of the disclosure, an apparatus for wireless communications is provided. The apparatus generally includes, while actively served in a first Radio Access Technology (RAT) network, means for obtaining neighbor cell measurements for a second RAT network; and means for making a decision on whether to perform a cell reselection to the second RAT network based on the neighbor cell measurements.

In an aspect of the disclosure, an apparatus for wireless communications is provided. The apparatus generally includes at least one processor and a memory coupled to the at least one processor. The at least one processor is typically adapted to, while actively served in a first Radio Access Technology (RAT) network, obtain neighbor cell measurements for a second RAT network; and make a decision on whether to perform a cell reselection to the second RAT network based on the neighbor cell measurements.

In an aspect of the disclosure, a computer-program product is provided. The computer-program product generally includes a computer-readable medium having code for, while actively served in a first Radio Access Technology (RAT) network, obtaining neighbor cell measurements for a second RAT network; and making a decision on whether to perform a cell reselection to the second RAT network based on the neighbor cell measurements.

### BRIEF DESCRIPTION OF THE DRAWINGS

FIG. 1 is a block diagram conceptually illustrating an example of a telecommunications system, in accordance with certain aspects of the present disclosure.

FIG. 2 is a block diagram conceptually illustrating an example of a frame structure in a telecommunications system, in accordance with certain aspects of the present disclosure.

FIG. 3 is a block diagram conceptually illustrating an example of a Node B in communication with a UE in a telecommunications system, in accordance with certain aspects of the present disclosure.

FIG. 4 illustrates a system in which a TD-SCDMA network may be combined with a GSM network, in accordance with certain aspects of the present disclosure.

FIGS. 5 and 6 illustrate hardware configurations for a user equipment (UE), in accordance with certain aspects of the present disclosure.

FIG. 7 illustrates example operations for performing cell reselection to a Radio Access Technology (RAT) network based on neighbor cell measurements, in accordance with certain aspects of the present disclosure.

FIG. 8 illustrates a timing diagram wherein a UE, comprising dual TD-SCDMA and GSM hardware, may perform cell reselection to a TD-SCDMA cell, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

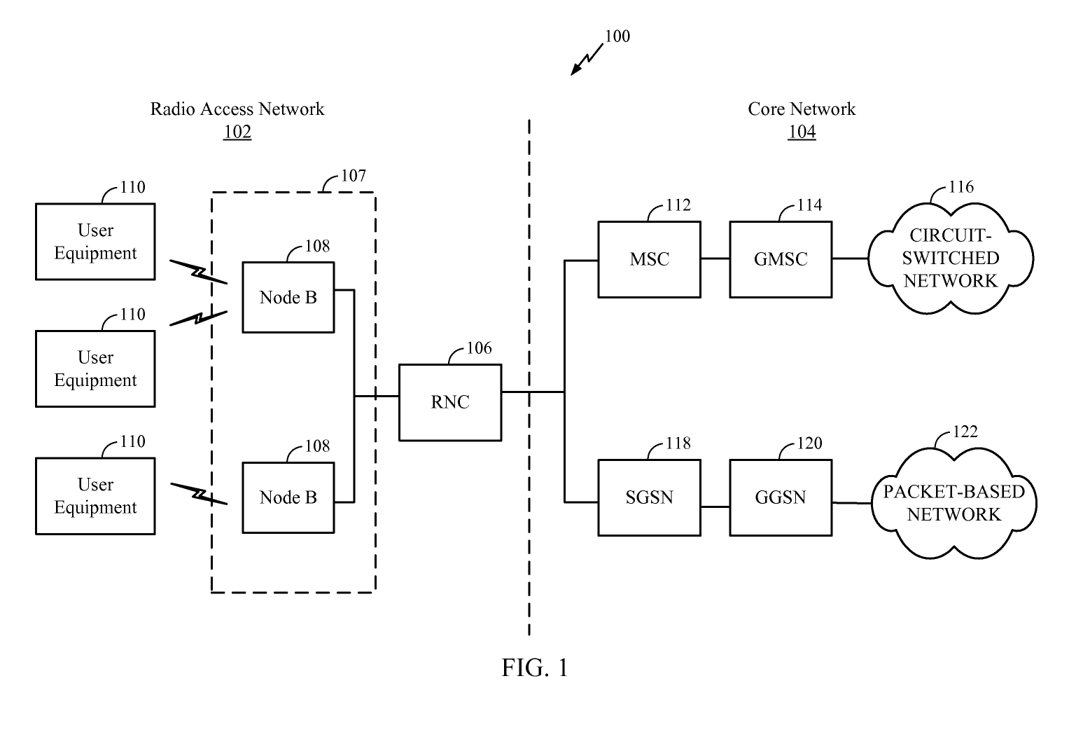

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the location of the UE and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

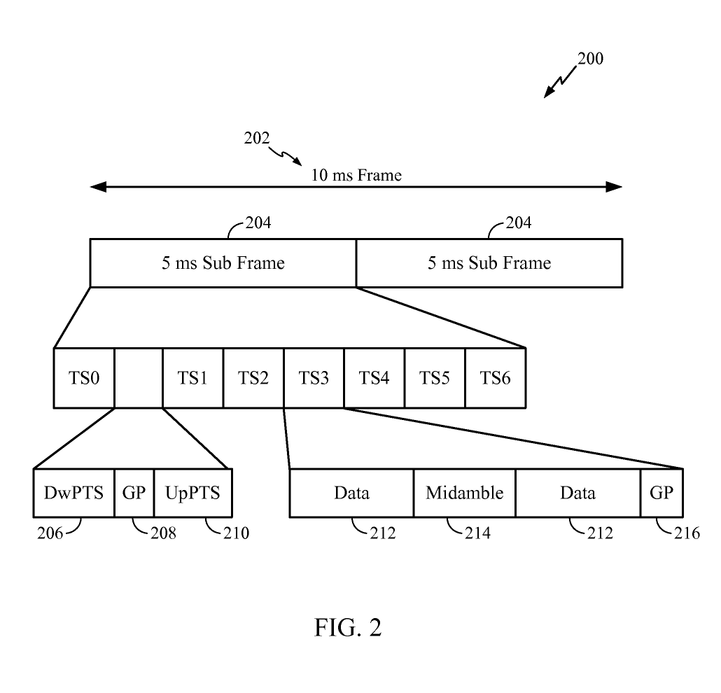

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The seven time slots may be used for regular traffic and signaling. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. DwPTS may be used to transmit DwPCH (Downlink Pilot Channel), which is for transmitting the pilot signal for the cell. The UpPCH may be used for the UE to perform initial random access procedure and UL synchronization in handover.

Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

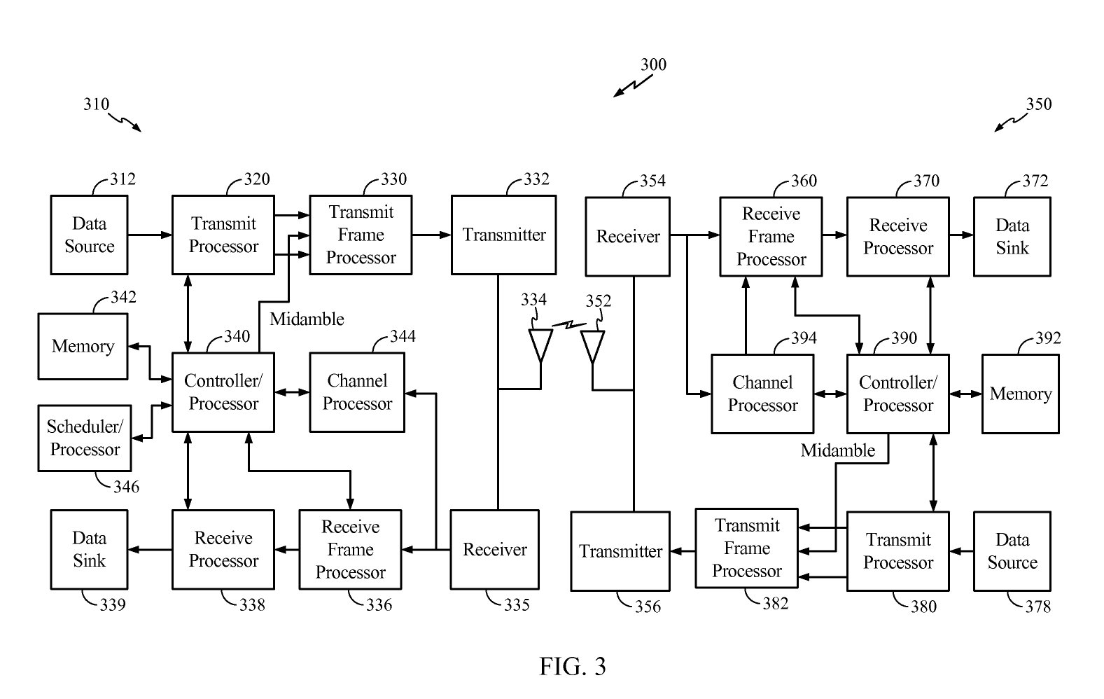

FIG. 3 is a block diagram of a Node B 310 in communication with a UE 350 in a

RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and de-spreads the symbols, and then determines the most likely signal constellation points transmitted by the Node B 310 based on the modulation scheme. These soft decisions may be based on channel estimates computed by the channel processor 394. The soft decisions are then decoded and de-interleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### TD-SCDMA Measurement in a Dual TD-SCDMA and GSM Mobile Station

TD-SCDMA (Time Division Synchronous Code Division Multiple Access) is based on time division and code division in order to allow multiple UEs (User Equipments) to share a same radio bandwidth on a particular frequency channel. The downlink and uplink transmissions share the same bandwidth in different time slots (TSs). In each time slot, there are multiple code channels.

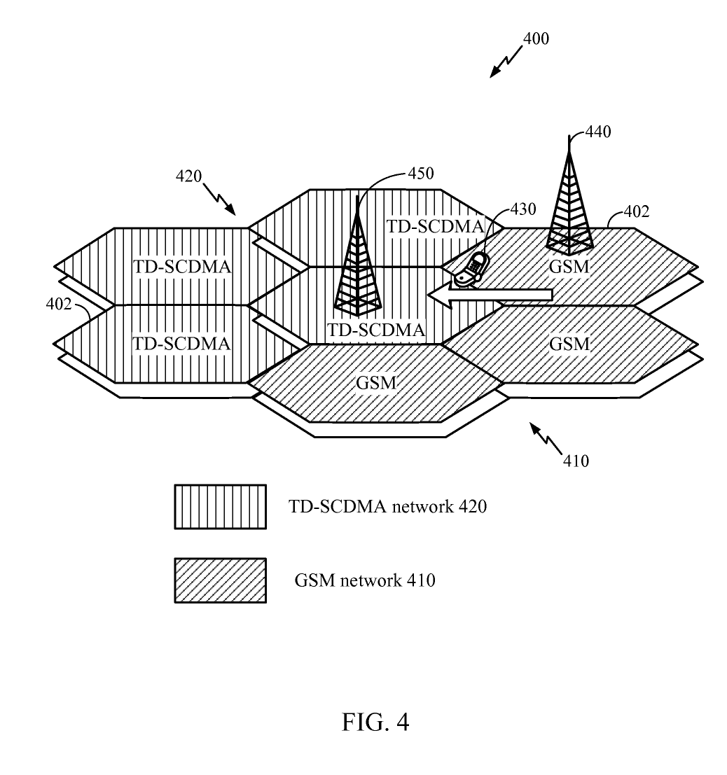

FIG. 4 illustrates an example system 400 in which TD-SCDMA network 420 may be combined with a GSM network 410. In certain locations, TD-SCDMA is being pursued as the underlying air interface in the UTRAN architecture with its existing GSM infrastructure as the core network. In the initial deployment of the TD-SCDMA network 420, it may cover limited areas, as illustrated in FIG. 4.

In the system, subscribers may employ a single multi-mode user equipment (UE) 430 to tune to both the GSM network 410 and the TD-SCDMA network 420.

FIG. 4 further illustrates that the GSM network 410 and the TD-SCDMA network 420 may be divided into regions, referred to as cells 402, centered around a base station. For example, cells 402 of the GSM network 410 may be centered around a GSM base station 440, and cells 402 of the TD-SCDMA network 420 may be centered around a TD-SCDMA base station 450. Therefore, a UE 430 may change from a cell operated by TD-SCDMA base station 450 to a cell operated GSM base station 440, and vice versa.

However, a GSM BCCH (Broadcast Control Channel) may not provide neighbor TD-SCDMA cell parameters in the system information for the UE 430 to search and measure neighbor TD-SCDMA cells quickly, particularly for the idle mode mobility from a GSM cell to a TD-SCMDA cell. Therefore, cell reselection of a TD-SCDMA cell may become very time consuming. The UE 430 may be required to blindly search for all radio channels in the TD-SCDMA in order to detect the neighbor TD-SCDMA cells and perform cell reselection.

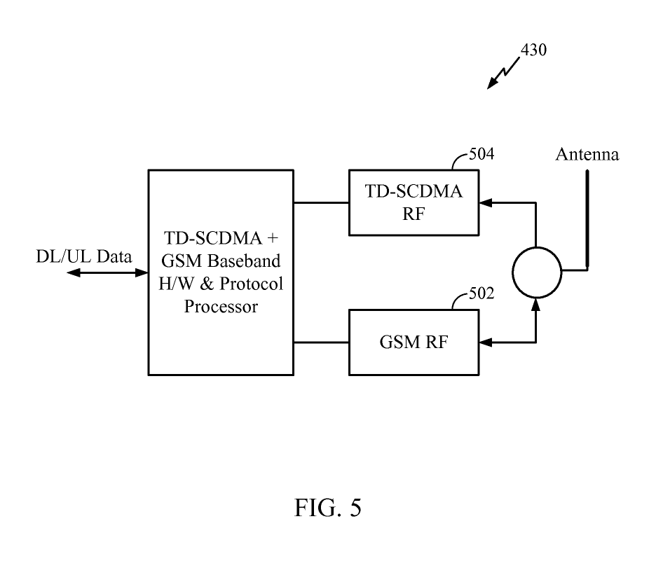

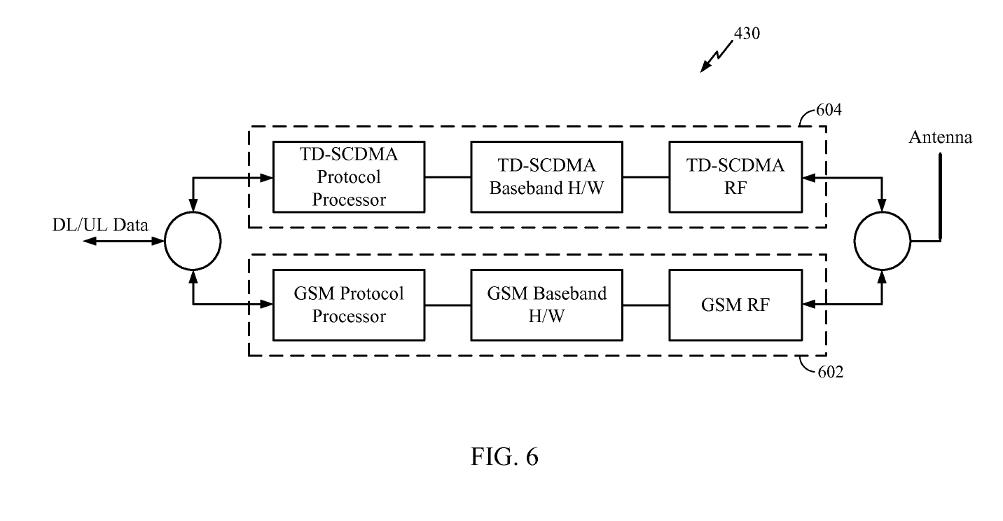

FIGS. 5 and 6 illustrate hardware configurations for a UE 430, according to certain embodiments of the present disclosure. As illustrated in FIG. 5, the UE 430 may comprise two independent receiver chains 502, 504, which may enable the UE 430 to simultaneously receive from both GSM and TD-SCDMA networks at any time (hereinafter, dual receive). As illustrated in FIG. 6, the UE 430 may comprise two independent modules 602, 604, which may enable the UE 430 to simultaneously transmit and receive from both GSM and TD-SCDMA networks at any time (hereinafter, dual transmit/receive). For certain embodiments of the present disclosure, the time spent for cell reselection on a UE 430 comprising dual TD-SCDMA and GSM hardware may be reduced, particularly when the UE 430 may not be given any neighbor cell information of TD-SCDMA cells while in the GSM network.

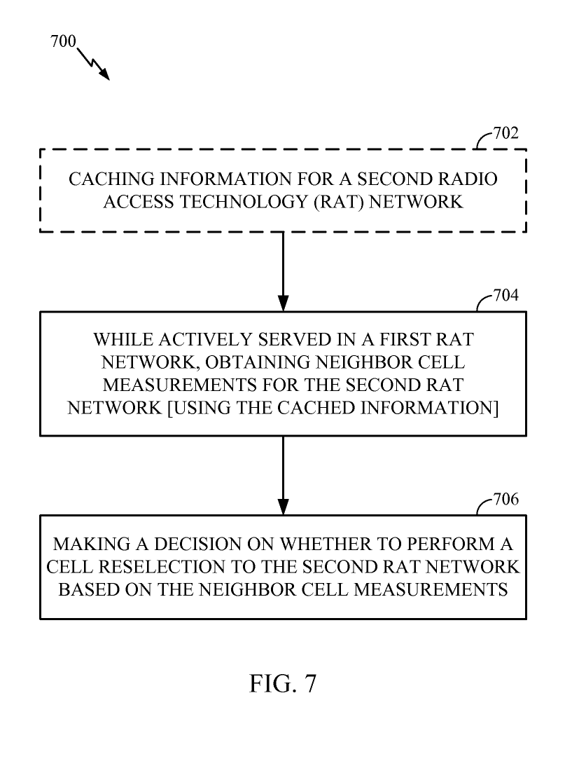

FIG. 7 illustrates example operations 700 in accordance with certain aspects of the present disclosure. The operations 700 may be performed, for example, by a UE 430 in performing cell reselection based on neighbor cell measurements. At 702, the UE 430 may cache information for a second Radio Access Technology (RAT) network (e.g., TD-SCDMA network). At 704, the UE 430 may, while actively served in a first RAT network (e.g., GSM network), obtain neighbor cell measurements for the second RAT network. For some embodiments, the neighbor cell measurements for the second RAT may be obtained using the previously cached information. At 706, the UE 430 may make a decision on whether to perform a cell reselection to the second RAT network based on the neighbor cell measurements.

According to 704, the UE 430 may turn on at least the receiver of a TD-SCDMA module in an effort to monitor the neighbor TD-SCDMA cells while in a GSM network, according to certain embodiments of the present disclosure. The TD-SCDMA module may comprise the dual receive or the dual transmit/receive hardware configurations. Therefore, the UE 430 may use the GSM module 502, 602 to listen to paging messages while performing the TD-SCDMA neighbor cell measurement. However, always performing TD-SCDMA neighbor cell measurements may consume an excessive amount of power.

For some embodiments, to prevent the TD-SCDMA module from always performing TD-SCDMA neighbor cell measurements, the TD-SCDMA module may be turned on to search and measure the neighbor cells only under certain conditions. For example, when the UE 430 may have lost the coverage in GSM, the TD-SCDMA module may be turned on to perform measurements. As a further example, the TD-SCDMA module may be turned on to perform measurements when all the neighbor GSM cells may have weak signal strength. For example, the GSM carrier RSSI (Received Signal Strength Indicator) may be less than a threshold for the serving and neighbor GSM cells. For some embodiments, the UE 430 may also periodically search for and measure the TD-SCDMA cells in the background in order to proactively detect one or more TD-SCDMA cells.

According to 702, to search for TD-SCDMA cells more effectively, the UE 430 may cache TD-SCDMA physical channel information obtained by the TD-SCDMA module, according to certain embodiments of the present disclosure. The information may comprise a cell's transmit frequency (i.e., UARFCN (UTRA Absolute Radio Frequency Channel Number)) and cell-specific scrambling codes and midamble shift. A cell may use one of 128 scramble codes for transmission. The cached information may be from previous search measurement results while the UE 430 was in a GSM network, as described above. Further, the cached information may be from a previously visited TD-SCDMA cell while the UE 430 was in a TD-SCDMA network, either in idle mode or connected mode. As another example, the cached information may be neighbor cell information acquired from a TD-SCDMA cell system information broadcast. In particular, the system information block type 15.5 may contain the neighbor cell information. In an effort to avoid too much cached cell parameter information, the cache may be managed with a time stamp, indicating when each cell parameter information was acquired. Therefore, when there may be too much cached information, the oldest cached cell parameter may be deleted. In other words, the previously cached information may be managed based on the age of the information.

At step 704, the UE 430 may search for or measure neighbor TD-SCDMA cells using the cached information described above (step 702). For example, rather than turning on the TD-SCDMA module when the UE 430 may have lost coverage in a GSM network, the UE 430 may search/measure using cached information that may have been obtained from previous search measurement results. The UE 430 may start to search for a neighbor TD-SCDMA cell using both the frequency and the cell specific scramble code and midamble shift obtained from the cached information. The priority of cell information used from the cached information may be according to the time stamps. Therefore, the latest information may be used first.

If a TD-SCDMA cell is not detected using the above-described method, then the UE 430 may search for a neighbor TD-SCDMA cell using only the frequency information. For some embodiments, the priority of cell information used from the cached information may be according to the time stamps. The UE 430 may need to try different cell specific scramble codes and midamble shifts on the frequency. If a TD-SCDMA cell cannot be found using the cached information, the UE 430 may turn on the TD-SCDMA module and begin an exhaustive search.

The TD-SCDMA network may be synchronous, in which the frame boundary of different TD-SCDMA cells may be in sync. For some embodiments, the TD-SCDMA module in the UE 430 may maintain the timing in the clock circuitry hardware once the UE 430 acquires the timing of any TD-SCDMA cell. For some embodiments, the UE 430 may cache timing information for the frame boundary. Therefore, the next time the UE 430 may be required to search for and measure TD-SCDMA cells, the UE 430 may use the existing timing that was acquired earlier.

After the TD-SCDMA module has obtained the search/measurement results using any of the above-described embodiments, the TD-SCDMA module may transmit the results to the GSM module to determine if cell reselection is needed (step 706). For example, the GSM module may determine that the UE 430 may be required to perform cell reselection to the TD-SCDMA network if the UE 430 lost coverage with a GSM cell. As a further example, cell reselection may be performed to the TD-SCDMA network if a TD-SCDMA cell has stronger signal strength than the a GSM cell by a margin that may be predefined. The signal strength of the TD-SCDMA cell may be determined from the RSCP (Receive Signal Code Power) measured on the P-CCPCH (Primary Common Control Physical Channel), and the signal strength of the GSM cell may be determined from the GSM carrier RSSI.

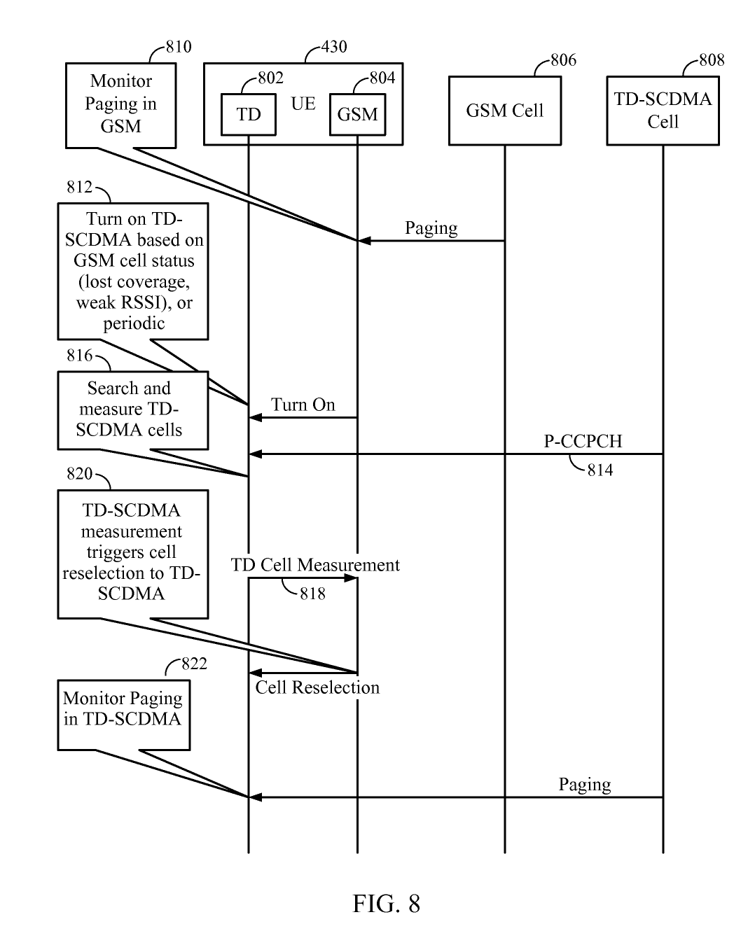

FIG. 8 illustrates a timing diagram wherein a UE 430, comprising dual TD-SCDMA and GSM hardware, may perform cell reselection to a TD-SCDMA cell 808, according to certain embodiments of the present disclosure. The UE 430 may comprise a TD-SCDMA module 802 and a GSM module 804, that may correspond, for example, to the dual receive configuration of FIG. 5 or the dual transmit/receive configuration of FIG. 6. The GSM cell 806 may correspond to a cell 402 of system 400 that may be operated by GSM base station 440, and the TD-SCDMA cell 808 may correspond to cell 402 of system 400 that may be operated by TD-SCDMA base station 450.

At 810, the UE 430 may use the GSM module 804 to listen to paging messages from the GSM cell 806. At 812, the UE 430 may turn on the TD-SCDMA module 802 to search/measure neighbor TD-SCDMA cells. The decision to turn on the TD-SCDMA module 802 may be based on information received at 810, such as lost GSM coverage or a weak RSSI. The TD-SCDMA module 802 may also be turned on periodically to proactively detect one or more TD-SCDMA cells. Further, rather than turning on the TD-SCDMA module 802, the UE 430 may use cached information from a previous search/measurement performed by the TD-SCDMA module 802, as described above.

The TD-SCDMA module 802 may receive information from neighboring TD-SCDMA cells via a P-CCPCH 814. For example, the RSCP may be measured on the P-CCPCH 814, indicating the signal strength of neighboring TD-SCDMA cells. At 816, the TD-SCDMA module 802 may search and measure the TD-SCDMA cells based on the information received via P-CCPCH 814.

At 818, the TD-SCDMA cell measurements may be transmitted to the GSM module 804. At 820, the GSM module 804 may determine whether cell reselection to the TD-SCDMA cell 808 is needed. For example, the GSM module 804 may determine that the UE 430 may be required to perform cell reselection to the TD-SCDMA cell 808 if the UE 430 lost coverage with the GSM cell 806. After cell reselection to the TD-SCDMA cell 808, the UE 430 may begin receiving paging messages from the TD-SCDMA cell 808.

Certain embodiments of the present disclosure may allow dual TD-SCDMA and GSM terminals to perform fast cell reselection to a TD-SCDMA cell without receiving the GSM broadcast of TD-SCDMA cell parameter information. Although embodiments of the present disclosure have been described using GSM and TD-SCDMA networks, cell reselection to other RAT networks may be performed by UEs capable of communicating with the other RAT networks.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications, comprising:
while actively served in a first Radio Access Technology (RAT) network, obtaining neighbor cell measurements for a second RAT network; and
making a decision on whether to perform a cell reselection to the second RAT network based on the neighbor cell measurements.

2. The method of claim 1, wherein obtaining the neighbor cell measurements for the second RAT network comprises using previously cached information.

3. The method of claim 2, wherein the previously cached information comprises results of previous neighbor cell measurements taken while served in the first RAT network.

4. The method of claim 2, wherein the previously cached information comprises results of previous neighbor cell measurements taken while served in the second RAT network.

5. The method of claim 2, wherein the previously cached information comprises neighbor cell information acquired from broadcast system information.

6. The method of claim 2, further comprising managing the previously cached information based on age of information.

7. The method of claim 2, wherein:
the previously cached information comprises at least one cell transmit frequency and a plurality of cell specific scrambling codes.

8. The method of claim 7, wherein obtaining the neighbor cell measurements for the second RAT network comprises performing cell searches using one or more combinations of a cached cell transmit frequency and cell specific scrambling code.

9. The method of claim 1, further comprising:
maintaining timing in the second RAT network; and
the neighbor cell measurements for the second RAT network are obtained using the maintained timing.

10. The method of claim 1, wherein making a decision on whether to perform a cell reselection to the second RAT network based on the neighbor cell measurements comprises:
deciding to perform cell reselection to the second RAT network if coverage in the first RAT network is lost.

11. The method of claim 1, wherein making a decision on whether to perform a cell reselection to the second RAT network based on the neighbor cell measurements comprises:
deciding to perform cell reselection to the second RAT network if signal strength of neighbor cells in the first RAT network are below a threshold value.

12. The method of claim 1, wherein obtaining the neighbor cell measurements for the second RAT network comprises:
powering on receive circuitry for receiving signals in the second RAT network;
taking neighbor cell measurements for the second RAT network: and
powering down the receive circuitry after taking the neighboring cell measurements for the second RAT network.

13. The method of claim 1, wherein the first RAT network is a Global System for Mobile Communications (GSM) network.

14. The method of claim 1, wherein the second RAT network is a Time Division—Synchronous Code Division Multiple Access (TD-SCDMA) network.

15. The method of claim 6, wherein managing comprises deleting a subset of the previously cached information based on the age of information.

16. An apparatus for wireless communications, comprising:
while actively served in a first Radio Access Technology (RAT) network, means for obtaining neighbor cell measurements for a second RAT network; and
means for making a decision on whether to perform a cell reselection to the second RAT network based on the neighbor cell measurements.

17. The apparatus of claim 16, wherein the means for obtaining the neighbor cell measurements for the second RAT network comprises means for using previously cached information.

18. The apparatus of claim 17, wherein the previously cached information comprises results of previous neighbor cell measurements taken while served in the first RAT network.

19. The apparatus of claim 17, wherein the previously cached information comprises results of previous neighbor cell measurements taken while served in the second RAT network.

20. The apparatus of claim 17, wherein the previously cached information comprises neighbor cell information acquired from broadcast system information.

21. The apparatus of claim 17, further comprising means for managing the previously cached information based on age of information.

22. The apparatus of claim 17, wherein:
the previously cached information comprises at least one cell transmit frequency and a plurality of cell specific scrambling codes.

23. The apparatus of claim 22, wherein the means for obtaining the neighbor cell measurements for the second RAT network comprises means for performing cell searches using one or more combinations of a cached cell transmit frequency and cell specific scrambling code.

24. The apparatus of claim 16, further comprising:
means for maintaining timing in the second RAT network; and
the neighbor cell measurements for the second RAT network are obtained using the maintained timing.

25. The apparatus of claim 16, wherein the means for making a decision on whether to perform a cell reselection to the second RAT network based on the neighbor cell measurements comprises:
means for deciding to perform cell reselection to the second RAT network if coverage in the first RAT network is lost.

26. The apparatus of claim 16, wherein means for making a decision on whether to perform a cell reselection to the second RAT network based on the neighbor cell measurements comprises:
means for deciding to perform cell reselection to the second RAT network if signal strength of neighbor cells in the first RAT network are below a threshold value.

27. The apparatus of claim 16, wherein the means for obtaining the neighbor cell measurements for the second RAT network comprises:
means for powering on receive circuitry for receiving signals in the second RAT network;
means for taking neighbor cell measurements for the second RAT network: and
means for powering down the receive circuitry after taking the neighboring cell measurements for the second RAT network.

28. The apparatus of claim 16, wherein the first RAT network is a Global System for Mobile Communications (GSM) network.

29. The apparatus of claim 16, wherein the second RAT network is a Time Division—Synchronous Code Division Multiple Access (TD-SCDMA) network.

30. The apparatus of claim 21, wherein the means for managing comprises means for deleting a subset of the previously cached information based on the age of information.

31. An apparatus for wireless communication, comprising:
at least one processor adapted to:
while actively served in a first Radio Access Technology (RAT) network, obtain neighbor cell measurements for a second RAT network; and
make a decision on whether to perform a cell reselection to the second RAT network based on the neighbor cell measurements; and
a memory coupled to the at least one processor.

32. The apparatus of claim 31, wherein the at least one processor adapted to obtain the neighbor cell measurements for the second RAT network comprises using previously cached information.

33. The apparatus of claim 32, wherein the previously cached information comprises results of previous neighbor cell measurements taken while served in the first RAT network.

34. The apparatus of claim 32, wherein the previously cached information comprises results of previous neighbor cell measurements taken while served in the second RAT network.

35. The apparatus of claim 32, wherein the previously cached information comprises neighbor cell information acquired from broadcast system information.

36. The apparatus of claim 32, wherein the at least one processor is adapted to manage the previously cached information based on age of information.

37. The apparatus of claim 32, wherein:
the previously cached information comprises at least one cell transmit frequency and a plurality of cell specific scrambling codes.

38. The apparatus of claim 37, wherein the at least one processor adapted to obtain the neighbor cell measurements for the second RAT network comprises performing cell searches using one or more combinations of a cached cell transmit frequency and cell specific scrambling code.

39. The apparatus of claim 31, wherein the at least one processor is adapted to:
maintain timing in the second RAT network; and
the neighbor cell measurements for the second RAT network are obtained using the maintained timing.

40. The apparatus of claim 31, wherein the at least one processor adapted to make a decision on whether to perform a cell reselection to the second RAT network based on the neighbor cell measurements comprises:
deciding to perform cell reselection to the second RAT network if coverage in the first RAT network is lost.

41. The apparatus of claim 31, wherein at least one processor adapted to make a decision on whether to perform a cell reselection to the second RAT network based on the neighbor cell measurements comprises:
deciding to perform cell reselection to the second RAT network if signal strength of neighbor cells in the first RAT network are below a threshold value.

42. The apparatus of claim 31, wherein the at least one processor adapted to obtain the neighbor cell measurements for the second RAT network comprises:
powering on receive circuitry for receiving signals in the second RAT network;
taking neighbor cell measurements for the second RAT network: and
powering down the receive circuitry after taking the neighboring cell measurements for the second RAT network.

43. The apparatus of claim 31, wherein the first RAT network is a Global System for Mobile Communications (GSM) network.

44. The apparatus of claim 31, wherein the second RAT network is a Time Division—Synchronous Code Division Multiple Access (TD-SCDMA) network.

45. The apparatus of claim 36, wherein the at least one processor adapted to manage comprises deleting a subset of the previously cached information based on the age of information.

46. A computer-program product, comprising:
a computer-readable medium comprising code for:
while actively served in a first Radio Access Technology (RAT) network, obtaining neighbor cell measurements for a second RAT network; and
making a decision on whether to perform a cell reselection to the second RAT network based on the neighbor cell measurements.

47. The computer-program product of claim 46, wherein the code for obtaining the neighbor cell measurements for the second RAT network comprises code for using previously cached information.

48. The computer-program product of claim 47, wherein the previously cached information comprises results of previous neighbor cell measurements taken while served in the first RAT network.

49. The computer-program product of claim 47, wherein the previously cached information comprises results of previous neighbor cell measurements taken while served in the second RAT network.

50. The computer-program product of claim 47, wherein the previously cached information comprises neighbor cell information acquired from broadcast system information.

51. The computer-program product of claim 47, further comprising code for managing the previously cached information based on age of information.

52. The computer-program product of claim 47, wherein:
the previously cached information comprises at least one cell transmit frequency and a plurality of cell specific scrambling codes.

53. The computer-program product of claim 52, wherein the code for obtaining the neighbor cell measurements for the second RAT network comprises code for performing cell searches using one or more combinations of a cached cell transmit frequency and cell specific scrambling code.

54. The computer-program product of claim 46, further comprising code for:
maintaining timing in the second RAT network; and
the neighbor cell measurements for the second RAT network are obtained using the maintained timing.

55. The computer-program product of claim 46, wherein the code for making a decision on whether to perform a cell reselection to the second RAT network based on the neighbor cell measurements comprises code for:
deciding to perform cell reselection to the second RAT network if coverage in the first RAT network is lost.

56. The computer-program product of claim 46, wherein the code for making a decision on whether to perform a cell reselection to the second RAT network based on the neighbor cell measurements comprises code for:
deciding to perform cell reselection to the second RAT network if signal strength of neighbor cells in the first RAT network are below a threshold value.

57. The computer-program product of claim 46, wherein the code for obtaining the neighbor cell measurements for the second RAT network comprises code for:
powering on receive circuitry for receiving signals in the second RAT network;
taking neighbor cell measurements for the second RAT network: and
powering down the receive circuitry after taking the neighboring cell measurements for the second RAT network.

58. The computer-program product of claim 46, wherein the first RAT network is a Global System for Mobile Communications (GSM) network.

59. The computer-program product of claim 46, wherein the second RAT network is a Time Division—Synchronous Code Division Multiple Access (TD-SCDMA) network.

60. The computer-program product of claim 51, wherein the code for managing comprises code for deleting a subset of the previously cached information based on the age of information.
